(19) United States
(12) Patent Application Publication
(10) Pub. No.: US 2020/0272896 A1
(43) Pub. Date: Aug. 27, 2020

(54) SYSTEM FOR DEEP LEARNING TRAINING USING EDGE DEVICES

(71) Applicant: ALIBABA GROUP HOLDING LIMITED, George Town (KY)

(72) Inventors: Wei WEI, San Mateo, CA (US); Lingjie XU, San Mateo, CA (US); Lingling JIN, San Mateo, CA (US); Wei ZHANG, San Mateo, CA (US)

(21) Appl. No.: 16/399,945

(22) Filed: Apr. 30, 2019

Related U.S. Application Data
(60) Provisional application No. 62/810,267, filed on Feb. 25, 2019.

(51) Int. Cl. G06N 3/08; G06N 20/00

(52) U.S. Cl. CPC G06N 3/08; G06N 20/00

(57) ABSTRACT

The present disclosure provides systems and methods for deep learning training using edge devices. The methods can include identifying one or more edge devices, determining characteristics of the identified edge devices, evaluating a deep learning workload to determine an amount of resources for processing, assigning the deep learning workload to one or more identified edge devices based on the characteristics of the one or more identified edge devices, and facilitating communication between the one or more identified edge devices for completing the deep learning workload.

### CROSS REFERENCE TO RELATED APPLICATION

The disclosure claims the benefits of priority to U.S. Provisional Application No. 62/810,267, filed on Feb. 25, 2019, which is incorporated herein by reference in its entirety.

### BACKGROUND

Recent growth of deep learning applications can require more and more computational resources. Data centers usually rely on powerful GPUs or ASIC chips to perform deep learning training. But deep learning computing is limited by the cost associated with purchasing or renting powerful devices. Moreover, there has not been a solution utilizing spare computing resources in terminal devices for deep learning with minimal cost.

### SUMMARY OF THE DISCLOSURE

The embodiments of the present disclosure provide a method for deep learning training using edge devices. The method includes identifying one or more edge devices; determining characteristics of the identified edge devices; evaluating a deep learning workload to determine an amount of resources for processing; assigning the deep learning workload to one or more identified edge devices based on the characteristics of the one or more identified edge devices; and facilitating communication between the one or more identified edge devices for completing the deep learning workload.

The embodiments of the present disclosure provide a server facilitating deep learning training uses edge devices. The server includes one or more network interfaces for communicating with the edge devices; a memory storing a set of instructions; and one or more processors configured to execute the set of instructions to cause the server to perform: identifying one or more edge devices; determining characteristics of the identified edge devices; evaluating a deep learning workload to determine an amount of resources for processing; assigning the deep learning workload to one or more identified edge devices based on the characteristics of the one or more identified edge devices; and facilitating communication between the one or more identified edge devices for completing the deep learning workload.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 illustrates a schematic diagram of an exemplary network environment, consistent with embodiments of the disclosure.

FIG. 2 illustrates a flow chart of an exemplary method for performing deep learning using edge devices, consistent with embodiments of the disclosure.

FIG. 3 illustrates a schematic diagram of an exemplary system with one or more edge devices performing deep learning workload, consistent with embodiments of the disclosure.

FIG. 4 illustrates a block diagram of an exemplary deep learning accelerator system, consistent with embodiments of the disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

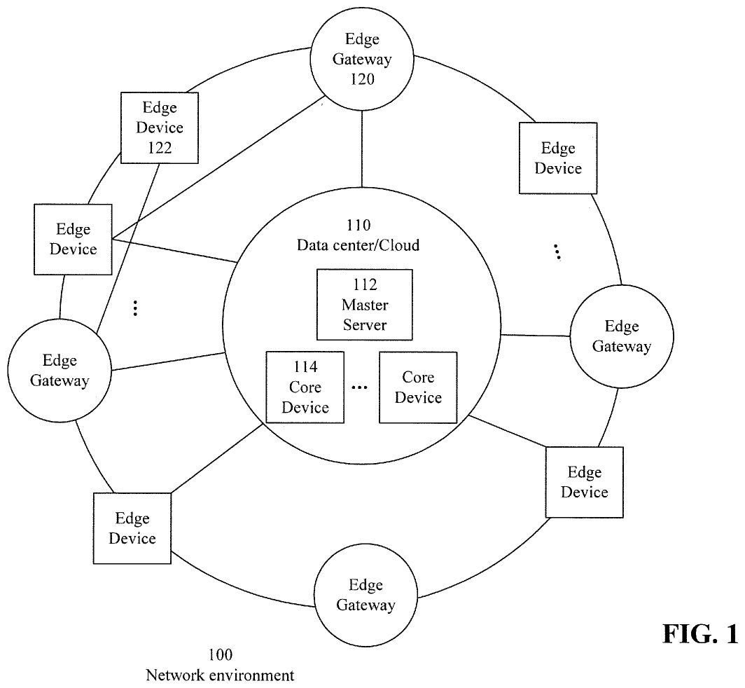

FIG. 1 illustrates a schematic diagram of an exemplary network environment 100, consistent with embodiments of the disclosure. In exemplary network environment 100, a data center/cloud 110 employs a master server 112 and a set of one or more core devices (e.g. core device 114 dedicated for training tasks and located in data center/cloud 110). Master server 112 can include a memory (e.g., a non-transitory computer readable medium) storing a set of instructions and one or more processor configured to execute the set of instructions. Moreover, master server 112 can include network interfaces that are communicatively coupled to the one or more processors and that send and receive communications from other devices such as core device 114 or edge devices. While master server 112 can be a standalone device providing instructions to the set of one or more core devices, it is appreciated that master server 112 may also be a core device and may be part of the set of one or more core devices. In one example, one of the core devices that are used for performing a workload in data center/cloud 110 can be designated as a master server when the workload starts.

Network environment 100 may also include edge devices (e.g. edge device 122) and edge gateways (e.g. edge gateway 120), all of which can be connected (directly or indirectly) with each other and with data center 110 via one or more communication links (e.g., high speed Internet). The edge device can be an endpoint device deployed in facilities where the edge device is connected with the data center. The edge device, in comparison to the core device that is dedicated to perform computation such as deep learning training in the data center, can be configured to split time between performing dedicated tasks (e.g. image processing) as designed by default and performing supplemental tasks including deep learning training when requested. Edge device 122 can be one of devices capable of artificial intelligence (AI) computation, such a device used in retail stores or industry facilities. Edge device 122 can also include a CPU and one or more accelerators that can train neural network models. The accelerator can be Neural Processing Unit (NPU), Graphics Processing Unit (GPU), Gated Recurrent Unit (GRU), and Field-Programmable Gate Arrays (FPGAs). For example, an edge device in use during business hours of the retail stores or the factory facilities can be used outside of business hours as a spare resource available for performing AI training. Taking advantage of the schedules of these types of edge devices may make it possible to perform computing workload without investing heavily on powerful AI devices.

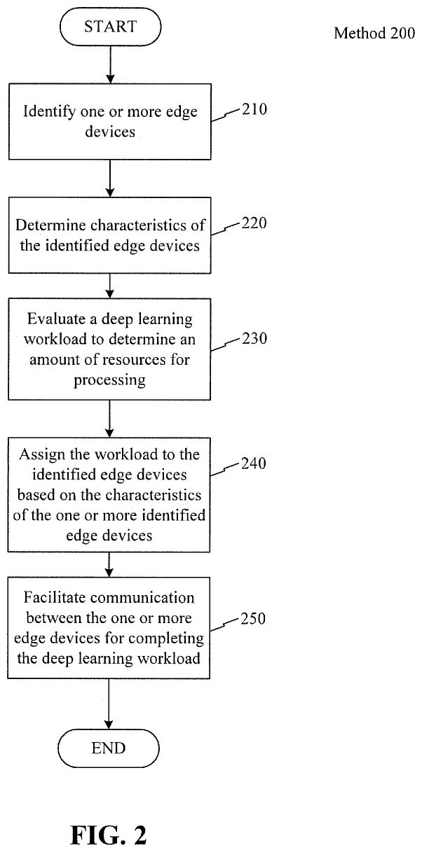

FIG. 2 illustrates a flow chart of an exemplary method 200 for performing deep learning using edge devices according to embodiments of the disclosure. Method 200 may be performed by a server (e.g., master server 112 of FIG. 1) or a collection of servers in a data center. The method can include the following steps.

In step 210, the server identifies one or more edge devices (e.g., edge device 122) that are available as resources. The server manages not only a collection of one or more core devices, but also a pool of edge devices with high speed Internet connection. One of the core devices in cloud (e.g. data center cloud 110) can maintain a database storing registration information of the edge devices and can obtain the registration information when the edge devices are deployed. The server can identify the edge device via the database as a candidate in the pool as long as the edge device employs a software framework required for the AI tasks and can train neural network models.

In step 220, the server determines characteristics of the identified edge devices. In some embodiments, the characteristics of the identified edge devices include memory size, availability, and computing resources (e.g., accelerators) and capabilities. The edge devices can include hardware accelerators such as GPU, FPGAs, and AI chips. The registration information of the edge devices can include the characteristics. The server can look up the characteristics of the edge devices in the database for workload allocation. The availability of the edge devices can indicate a schedule when the edge devices are more likely available to perfoiiu a deep learning workload. For example, while using a cash register for AI tasks may not be efficient during business hours, the server may find that the cash register has appropriate resources for performing computations outside of business hours. During the down time of the cash register, it can be assigned all or part of a deep learning workload based on its computing capabilities. The cash register can split its available time or the computing resources on tasks designated by default (e.g. transaction registering) and tasks provided by the server (e.g. AI computation). In another example, AI-powered surveillance cameras that employ hardware to process AI algorithms in stores can also be configured to perform computations outside of business hours. The server can control and manage the cameras to perform the deep learning training during idle time. In another example, the edge devices can include intelligent machines that are configured to perform identifying boxes, classifying images and other tasks during daytime in a warehouse. During nighttime, the intelligent machines can be allocated to perform AI training to fully utilize the computating resources.

In step 230, the server evaluates a deep learning workload to determine the appropriate amount of resources for processing. The server can also identify percentage (e.g. 50% idling) of the computing resources that the edge device can spare for computing.

In step 240, the server assigns the workload to one or more identified edge devices based on the characteristics of the edge devices. In some embodiments, the server uses model parallelism to split computing graph nodes into groups of nodes based on the memory size of the edge devices and dispatch the groups to the edge devices. In model parallelism, the split groups can be evaluated concurrently. For example, if an edge device has a larger memory size, more computing graph nodes can be deployed on the edge device. In an example of an edge device with a memory not large enough to hold a whole model, the server can still distribute pieces of the model to the edge device based on the size of the memory with model parallelism. In model parallelism, one layer can be split across the edge devices to be evaluated in parallel. Each processor or set of processors (e.g., such as a host and a GPU) in the edge device works on a part of the model rather than a part of the data. In deep learning, model parallelism can be implemented by splitting weights among the GPUs. A large neural network whose weights do not fit into the memory of a single GPU can be processed by using model parallelism. According to some embodiments, a master server (e.g. master server 112 shown in FIG. 1) can coordinate the computing graph split and communications between the edge devices. In some embodiments, the computing capabilities can include convolution, rectification, batch normalization, and pooling. The system can assign the workload based on what type of computation the edge device is capable of performing. In one example, during daytime the core devices can perform the training tasks. During night, the identified edge devices and the core devices can share the workload. The identified edge devices can save all checkpoint files when a training period ends in one night and resume computing on the next available night. By sharing the workload, the server can greatly reduce time to complete certain training tasks. In another example, the edge devices can be used as backup resources during the idle time and take over the tasks when the core devices shut down or encounter failures. The use of edge devices is significant. For example, the processing capability of four or five edge devices is currently equivalent of that of a core device. Accordingly, when a network associated with a data center employs hundreds or thousands of edge devices, the use of these edge devices can improve the processing efficiency of the data center.

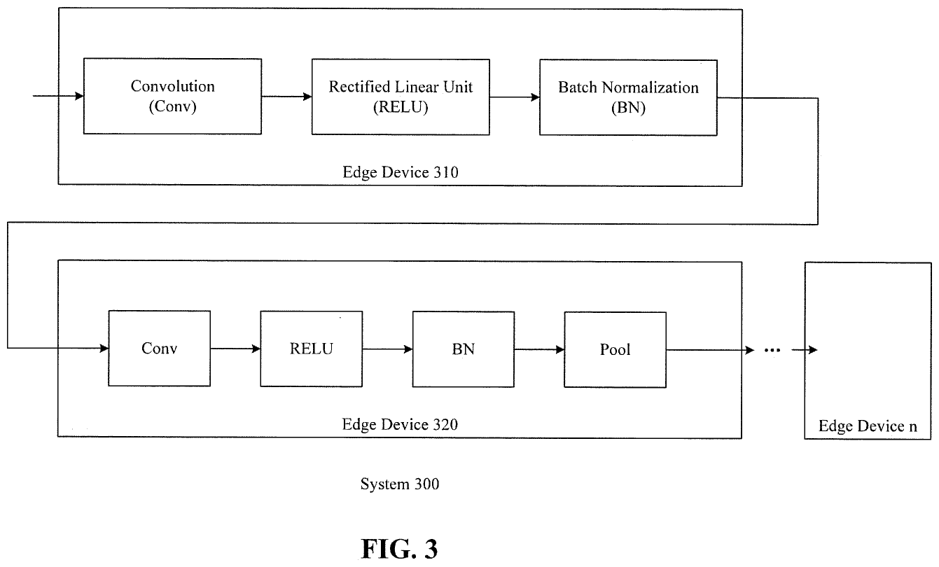

Exemplary edge devices shown in FIG. 3 can be equipped with the above mentioned computing capabilities. For example, as shown in FIG. 3, edge device 310 can provide capabilities for performing convolution, rectification, and batch normalization via Convolution Unit (Cony), Rectified Linear Unit (RELU) and Batch Normalization Unit (BN) respectively. Another edge device 320 can work together with edge device 310 and perform convolution, rectification, batch normalization and pooling operations. The rectification can be used as an activation function in deep neural networks. The batch normalization can be used to standardize inputs to a network, applied either activations of a prior layer or inputs directly to accelerate training. In an example, software frameworks that support a deep learning training scheme can also be installed on the edge devices.

Now referring back to FIG. 2, in step 250, optionally, the system facilitates communications between the identified edge devices for completing the workload. Data input to edge device 310 is computed. For example, input values such as weights and bias values are stored in a memory of an edge device. When computing an output of a computing graph node, the inputs are multiplied by the weights and a bias value is added to the result. Biases can be tuned alongside weights. This output can be transferred to edge device 320 for further computation. It is appreciated that edge device 310 communicates directly with edge device 320. It is also appreciated that edge device 310 can communicate with data center 110 (e.g. via master server 112) shown in FIG. 1 for uploading computation results, after which data center 110 transfer received data to edge device 320 as inputs for further computing. When the input data is transmitted to a current computing graph node, the group of nodes is computed when the dependency is met. When the data is finished computing, the data can be sent to the next edge device. In one example, the server can determine how long it takes to process each layer of the neural network on each edge device based on available time and the computing resources of the edge device stored in the database. The server can schedule the training tasks such that each participating edge device spends similar execution time. Therefore, the tasks are not bottlenecked on any edge device that takes considerably longer time to process.

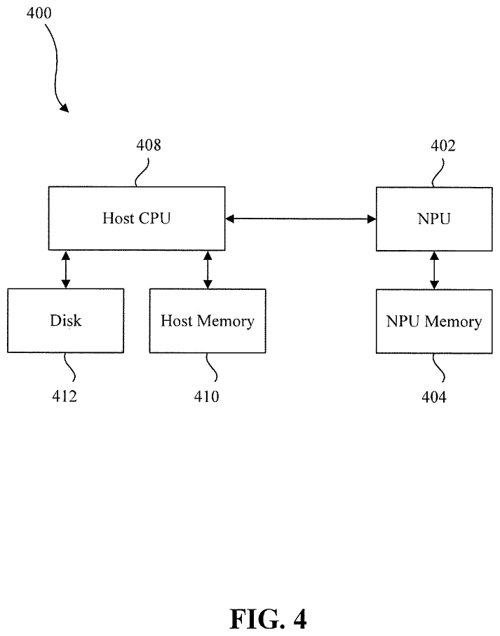

The system for deep learning training can employ an accelerator that includes DRAM, CPUs, network interface controller (NIC). Accelerators that use application specific integrated circuits (ASICs), field programmable gate arrays (FPGAs), and graphic processing units (GPUs) can be employed for deep learning. FIG. 4 illustrates a block diagram of an exemplary deep learning accelerator system, according to embodiments of the disclosure. The exemplary deep learning accelerator system (e.g. deep learning accelerator system 400) may include a neural network processing unit (NPU) 402, a NPU memory 404, a host CPU 408, a host memory 410 associated with host CPU 408, and a disk 412. The edge device may include the deep learning accelerator system for perfoiniing the training tasks. It is appreciated that while FIG. 4 shows the accelerator system as using an NPU, any type of accelerator can be used.

As illustrated in FIG. 4, NPU 402 may be connected to host CPU 408 through a peripheral interface. As referred to herein, a neural network processing unit (e.g., NPU 402) may be a computing device for accelerating neural network computing tasks. In some embodiments, NPU 402 may be configured to be used as a co-processor of host CPU 408.

In some embodiments, NPU 402 may comprise a compiler (not shown). The compiler may be a program or a computer software that transforms computer code written in one programming language into NPU instructions to create an executable program. In machining applications, a compiler may perform a variety of operations, for example, pre-processing, lexical analysis, parsing, semantic analysis, conversion of input programs to an intermediate representation, code optimization, code generation, or combinations thereof.

It is appreciated that the first few instructions received by the processing element may instruct the processing element to load/store data from the global memory into one or more local memories of the processing element (e.g., a memory of the processing element or a local memory for each active processing element). Each processing element may then initiate the instruction pipeline, which involves fetching the instruction (e.g., via a fetch unit) from the local memory, decoding the instruction (e.g., via an instruction decoder) and generating local memory addresses (e.g., corresponding to an operand), reading the source data, executing or loading/storing operations, and then writing back results.

Host CPU 408 may be associated with host memory 410 and disk 412. In some embodiments, host memory 410 may be an integral memory or an external memory associated with host CPU 408. Host memory 410 may be a local or a global memory. In some embodiments, disk 412 may comprise an external memory configured to provide additional memory for host CPU 408.

In some embodiments, a non-transitory computer-readable storage medium including instructions is also provided, and the instructions may be executed by a device (such as master server 112 or one or more core devices on data center/cloud 110), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A method for deep learning processing, comprising:
identifying one or more edge devices;
determining characteristics of the identified edge devices;
evaluating a deep learning workload to determine an amount of resources for processing;
assigning the deep learning workload to one or more identified edge devices based on the characteristics of the one or more identified edge devices; and
facilitating communication between the one or more identified edge devices for completing the deep learning workload.

2. The method according to claim 1, wherein the characteristics of the identified edge devices comprise at least one of memory size, availability, or computing capabilities.

3. The method according to claim 2, wherein assigning the workload to the one or more identified edge devices comprise:
splitting computing graph nodes into groups of nodes based on the memory size of the edge devices; and
dispatching the groups of nodes to the edge devices.

4. The method according to claim 3, wherein the computing graph nodes are split using model parallelism with which the split groups are evaluated concurrently.

5. The method according to claim 2, wherein the computing capabilities comprise at least one of convolution operations, rectification operations, batch normalization operations, or pooling operations.

6. The method according to claim 1, wherein facilitating communication between the one or more identified edge devices for completing the deep learning workload comprise:
estimating a completion time that each edge device requires to complete the deep learning workload; and
scheduling the deep learning workload on the one or more edge devices based on the completion time of the one or more edge devices.

7. A server comprising:
one or more network interfaces;
a memory storing a set of instructions; and
one or more processors configured to execute the set of instructions to cause the server to perform:
identifying one or more edge devices;
determining characteristics of the identified edge devices;
evaluating a deep learning workload to determine an appropriate amount of resources for processing;
assigning the workload to one or more identified edge devices based on the characteristics of the one or more identified edge devices; and
facilitating communication between the one or more identified edge devices for completing the workload.

8. The server according to claim 7, wherein the characteristics of the identified edge devices comprise at least one of memory size, availability, or computing capabilities.

9. The server according to claim 8, wherein assigning the workload to the one or more identified edge devices comprise:
splitting computing graph nodes into groups of nodes based on the memory size of the edge devices; and
dispatching the groups of nodes to the edge devices.

10. The server according to claim 9, wherein the computing graph nodes are split using model parallelism with which the split groups are evaluated concurrently.

11. The server according to claim 8, wherein the computing capabilities comprise at least one of convolution operations, rectification operations, batch normalization operations, or pooling operations.

12. The server according to claim 7, wherein facilitating communication between the one or more identified edge devices for completing the deep learning workload comprise:
estimating a completion time that each edge device requires to complete the deep learning workload; and
scheduling the deep learning workload on the one or more edge devices based on the completion time of the one or more edge devices.

13. A non-transitory computer readable medium that stores a set of instructions that is executable by at least one processor of a computer to cause the computer to perform a method for deep learning processing, the method comprising:
identifying one or more edge devices;
determining characteristics of the identified edge devices;
evaluating a deep learning workload to determine an appropriate amount of resources for processing;
assigning the deep learning workload to one or more identified edge devices based on the characteristics of the one or more identified edge devices; and
facilitating communication between the one or more identified edge devices for completing the deep learning workload.

14. The non-transitory computer medium according to claim 13, wherein the characteristics of the identified edge devices comprise at least one of memory size, availability, or computing capabilities.

15. The non-transitory computer medium according to claim 14, wherein assigning the workload to the one or more identified edge devices comprise:
splitting computing graph nodes into groups of nodes based on the memory size of the edge devices; and
dispatching the groups of nodes to the edge devices.

16. The non-transitory computer medium according to claim 15, wherein the computing graph nodes are split using model parallelism with which the split groups are evaluated concurrently.

17. The non-transitory computer medium according to claim 14, wherein the computing capabilities comprise at least one of convolution operations, rectification operations, batch normalization operations, or pooling operations.

18. The non-transitory computer medium according to claim 13, wherein facilitating communication between the one or more identified edge devices for completing the deep learning workload comprise:
estimating a completion time that each edge device requires to complete the deep learning workload; and
scheduling the deep learning workload on the one or more edge devices based on the completion time of the one or more edge devices.
